(19) United States
(12) Patent Application Publication
(10) Pub. No.: US 2017/0321532 A1
(43) Pub. Date: Nov. 9, 2017

(54) IDENTIFYING AND DETERMINING WEAR OF A COMPONENT USED IN A WELL OPERATION

(71) Applicant: Blake C. Burnette, Tomball, TX (US)

(72) Inventor: Blake C. Burnette, Tomball, TX (US)

(73) Assignee: Baker Hughes Incorporated, Houston, TX (US)

(21) Appl. No.: 15/149,946

(22) Filed: May 9, 2016

(51) Int. Cl. E21B 47/00; G01F 3/00

(52) U.S. Cl. CPC E21B 47/00; G01F 3/00

(57) ABSTRACT

Examples of techniques identifying and determining wear of a component used in a well operation are disclosed. In one example implementation according to aspects of the present disclosure, a method may include: identifying the component from a plurality of components, wherein an identifier is connected to the component, the identifier comprising a unique identifier to identify the component from the plurality of components; measuring a volume of sand passing through the component over a period of time; measuring a volume of fluid passing through the component over the period of time; and determining, by the processing system, a failure risk level for the component based at least in part on the volume of sand passing through the component over the period of time and based at least in part on the volume of fluid passing through the component over the period of time.

### BACKGROUND

The present disclosure relates to well operations and, more particularly, to identifying and determining wear of a component used in a well operation.

Boreholes are drilled into earth formations having reservoirs of hydrocarbons in order to extract the hydrocarbons through the boreholes to the surface. Various components (e.g., pipe segments, pipe couplings, pipe valves, manifolds, etc.) connect equipment trucks (e.g., blending trucks, pumping trucks, etc.) at the earth's surface to the bore holes. The components that connect the equipment trucks to the boreholes carry fluid, such as drilling fluid, to the boreholes to be used to extract the hydrocarbons through the boreholes. The drilling fluid may be a mixture of solids (e.g., sand) and liquids (e.g., water). Over time, the drilling fluid may cause damage to or otherwise degrade the components, thereby shortening the useful life of a component and/or leading to catastrophic failure of a component.

### BRIEF SUMMARY

According to aspects of the present disclosure, techniques including methods, systems, and/or computer program products for identifying and determining wear of a component used in a well operation are provided. An example method may include: identifying, by a processing system, the component from a plurality of components, wherein an identifier is connected to the component, the identifier comprising a unique identifier to identify the component from the plurality of components; measuring, by a density sensor in fluid communication with the component used in the well operation, a volume of sand passing through the component over a period of time; measuring, by a flow sensor in fluid communication with the component used in the well operation, a volume of fluid passing through the component over the period of time; and determining, by the processing system, a failure risk level for the component based at least in part on the volume of sand passing through the component over the period of time and based at least in part on the volume of fluid passing through the component over the period of time.

According to additional aspects of the present disclosure, an example system may include: a memory having computer readable instructions; and a processing device for executing the computer readable instructions. The computer readable instructions may include: identifying the component from a plurality of components, wherein an identifier is connected to the component, the identifier comprising a unique identifier to identify the component from the plurality of components; measuring a density of a fluid flowing through the component over a period of time; and determining, by the processing system, a failure risk level for the component based at least in part on density of the fluid flowing through the component over the period of time.

Additional features and advantages are realized through the techniques of the present disclosure. Other aspects are described in detail herein and are considered a part of the disclosure. For a better understanding of the present disclosure with the advantages and the features, refer to the following description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings in which:

FIG. 1 illustrates a block diagram of a plurality of components connected to pump trucks used in a well operation and an identification and wear determination system to determine wear of the components according to aspects of the present disclosure;

FIG. 2 illustrates a block diagram of a processing system to identify and determine wear of a component used in a well operation according to aspects of the present disclosure;

FIG. 3 illustrates a flow diagram of a method for identifying and determining wear of a component used in a well operation according to aspects of the present disclosure; and

FIG. 4 illustrates a block diagram of a processing system for implementing the techniques described herein according to examples of the present disclosure.

### DETAILED DESCRIPTION

Various implementations are described below by referring to several examples of determining wear of a component or components. The components described herein may be pipe segments, pipe couplings, pipe valves, manifolds, and the like, and may be constructed partially, substantially, or wholly from iron. However, in other examples, the components described herein may be comprised of materials other than or in addition to iron.

The present techniques reduce the likelihood of a catastrophic failure of a component by identifying a component and tracking the amount of solid and fluid (e.g., sand and water) traveling through the component over time. By tracking this information, a user can be alerted when a component reaches a threshold level of solid and fluid traveling through the component that may cause the component to degrade. This enables the components to be removed from use and/or serviced to prevent a failure. These and other advantages will be apparent from the description that follows.

The teachings of the present disclosure can be applied in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

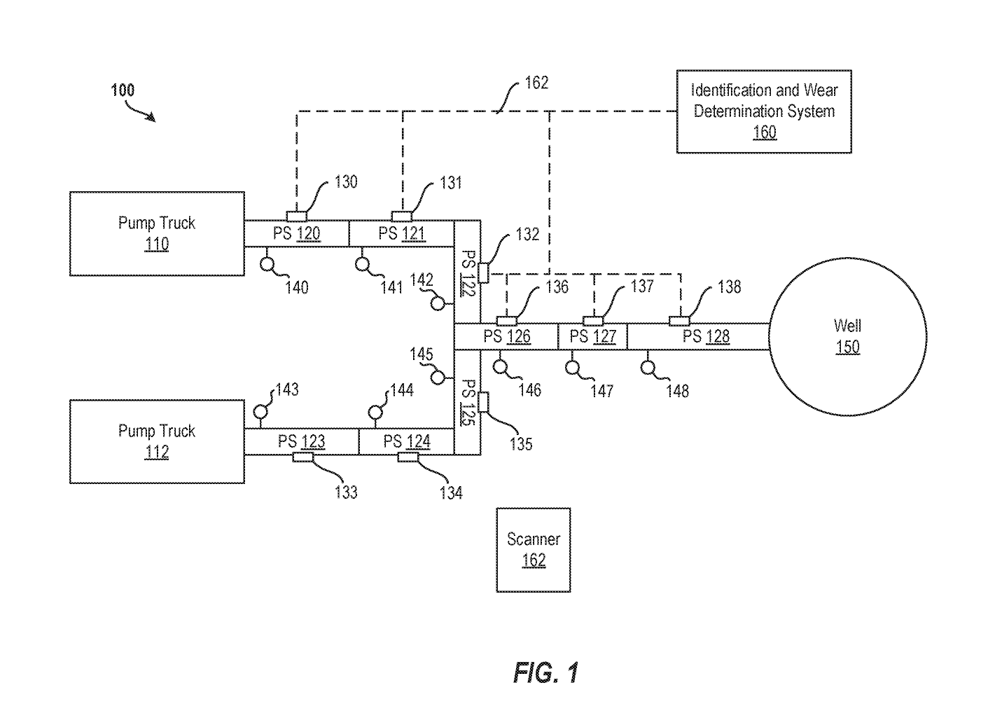

FIG. 1 illustrates a block diagram of a plurality of components (e.g., pipe segments (PS) 120, 121, 122, 123, 124, 125, 126, 127, 128) connected to pump trucks 110, 112 used in a well operation 100 and an identification and wear determination system 160 to determine wear of the components. The plurality of pipe segments 120-128 each include an identifier 130, 131, 132, 133, 134, 135, 136, 137, 138 connected to the pipe segments 120-128 respectively.

It should be appreciated that, although pipe segments are illustrated in and discussed with respect to FIG. 1, other components as discussed herein may be implemented instead of, in addition to, and/or in combination with the pipe segments 120-128. Additionally, the pump trucks 110, 112 may be other types of trucks or equipment suitable for use at the well operation 100, and the description of pump trucks should not be interpreted as limiting.

In aspects of the present disclosure, the identifiers 130-138 may be barcodes, radio frequency identification (RFID) tags (i.e., an active RFID tag or a passive RFID tag), microcontrollers comprising an input/output (I/O) connection, and/or other devices for automatic identification and data capture. In each case, the identifiers 130-138 identify the pipe segments 120-128 using a unique identifier that is unique to each of the pipe segments 120-128.

In an example in which the identifiers 133-135 comprise barcodes, the unique identifiers for each of the identifiers 133-135 may be barcode sequences that are unique to each segment. Continuing with the barcode example, a scanner 162 may be used to scan each of the identifiers 133-135, for example, when the pipe segments 123-125 respectively are installed, removed, replaced, etc., at the well operation 100. A user (not shown) may scan the identifiers 133-135 by hand, for example, by walking around to each pipe segment 123-125 and scanning the identifiers 133-135 with the scanner 162. As the identifiers 133-135 are scanned, a time stamp may be associated with the unique identifier, either manually or automatically. The scanner 162 may be configured to transmit data to and receive data from the identification and wear determination system 160 using wired and or wireless communication.

Where the identifiers 133-135 are active or passive RFID tags, the unique identifiers may be a unique electronic code stored in each RFID tag that uniquely identifies each pipe segment 123-125 respectively. In this case, the scanner 162 may be a RFID scanner that scans the RFID tags, either actively or passively. In the case of active RFID tags, the scanner 162 may be installed at the well operation 100. However, in the case of passive RFID tags, the scanner 162 may be used by a user to scan the identifiers 133-135 by hand by moving the scanner 162 in proximity to the pipe segments 123-125 respectively. According to examples of the present disclosure, multiple scanners 162 may be utilized.

In an example using a microcontroller, the microcontroller may also store a unique electronic code that uniquely identifies each pipe segment 120-128 respectively, which may be output via the I/O connection 162 connected to the identification and wear determination system 160. It should be appreciated that the I/O connection 162 may be a wired connection, a wireless connection, or a combination thereof.

Each of the pipe segments 120-128 include a density sensor and/or a flow sensor, which may be individual sensors or which may be combined as a sensor array. Sensors 140, 141, 142, 143, 144, 145, 146, 147, 148 are illustrated in FIG. 1 as corresponding respectively to pipe segments 120-128. The sensors 140-148 measure a volume of solid (e.g., sand) and a volume of fluid (e.g., water) passing through the respective pipe segments 120-128 over a period of time. Although not illustrated in FIG. 1, the sensors 140-148 are configured to transmit the measurements via wired and/or wireless communication links to the identification and wear determination system 160.

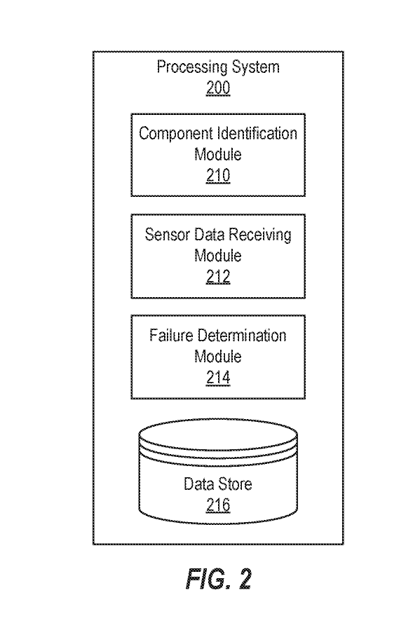

The identification and wear determination system 160 identifies components and determines a failure risk level (e.g., determines the amount of wear) for the components. An example of an identification and wear determination system 160 is illustrated as processing system 200 of FIG. 2 and is discussed below.

In particular, FIG. 2 illustrates a block diagram of a processing system 200 to identify and determine wear of a component used in a well operating according to examples of the present disclosure. The processing system 200 is one example of the identification and wear determination system 160 illustrated in FIG. 1, and the functionality of the processing system 200 is discussed below with reference to the elements illustrated in FIG. 1.

The various components, modules, engines, etc. described regarding FIG. 2 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein may be a combination of hardware and programming. The programming may be processor executable instructions stored on a tangible memory, and the hardware may include a processing device for executing those instructions. Thus, a system memory can store program instructions that when executed by a processing device implement the modules described herein. Other modules may also be utilized to include other features and functionality described in other examples herein.

In aspects of the present disclosure, processing system 200 includes a component identification module 210, a sensor data receiving module 212, a failure determining module 214, and a data store 216. Alternatively or additionally, the processing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

The component identification module 210 identifies a component from a plurality of components using an identifier connected to the component. The identifier includes a unique identifier to identify the component from the plurality of components. For example, a user may scan a barcode, RFID tag, or another identifier on a component (or multiple components). The component identification module 210 identifies the component based on data stored in the data store 216. For example, the unique identifier of the component is stored in the data store 216 along with any relevant data relating to the component, such as a time stamp when the component is installed, serviced, removed, etc.

The sensor data receiving module 212 receives data relating to solid and fluid passing through the component. For example, a sensor (e.g., a density sensor) measures a volume of sand passing through the component over a period of time. Similarly, a sensor (e.g., a flow sensor) measures a volume of fluid passing through the component over the period of time. The sensor data receiving module 212 receives the sensor data from the respective sensors (or sensor array). Additionally, in examples, the sensor data receiving module 212 stores the received sensor data to the data store 216.

The failure determination module 214 determines a failure risk level for the component using the received sensor data and/or the data stored in the data store 216. For example, the failure determination module 214 determines a failure risk level for the component based at least in part on the volume of sand passing through the component over the period of time and based at least in part on the volume of fluid passing through the component over the period of time. The data store 216 stores the period of time that the component is used (e.g., a number of hours during which the component had fluid flowing through the pipe). The period of time is useful in calculation degradation of the component. For example, an iron pipe segment may be known to degrade at a certain rate. By knowing the period of time that the pipe segment is in use, the failure determination module 214 can determine the failure risk level. The failure risk level may be, for example, a low/medium/high classification, a rating from 1 to 5 with 1 being highly unlikely that a component failure will occur and with 5 being highly likely that a component failure will occur.

In examples, when the failure risk level exceeds a first threshold, the component is removed from the well operation. In aspects of the present disclosure, when the failure risk level exceeds a second threshold, the well operation is halted. The first threshold may be a lower threshold than the second threshold in examples of the present disclosure. This enables the well operation to continue until the component is replaced even if the failure risk level exceeds the first threshold but prevents a catastrophic failure by halting well operations when the second threshold is exceeded (or met in some examples). In examples, the first threshold may indicate that the component should be serviced rather than removed from the well operation. In an example using the low/medium/high classification, the first threshold may be a medium classification and the second threshold may be a high classification such that once a medium classification is reached, the component is removed or serviced and once a high classification is reached, the well operation is halted.

In additional examples, the processing system 200 may include additional modules. For example, the processing system 200 may include a reporting module to report the failure risk level for the component by transmitting the identifier associated with the component and the failure risk level to a user device.

According to further examples of the present disclosure, the sensor data receiving module 212 receives a density of a fluid flowing through the component over a period of time from a density sensor. The failure determination module 214 determines a failure risk level for the component based at least in part on the density of the fluid flowing through the component over the period of time.

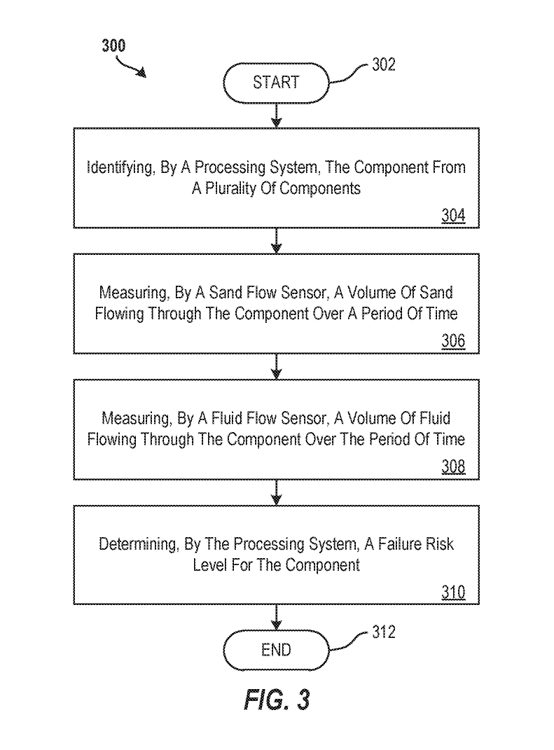

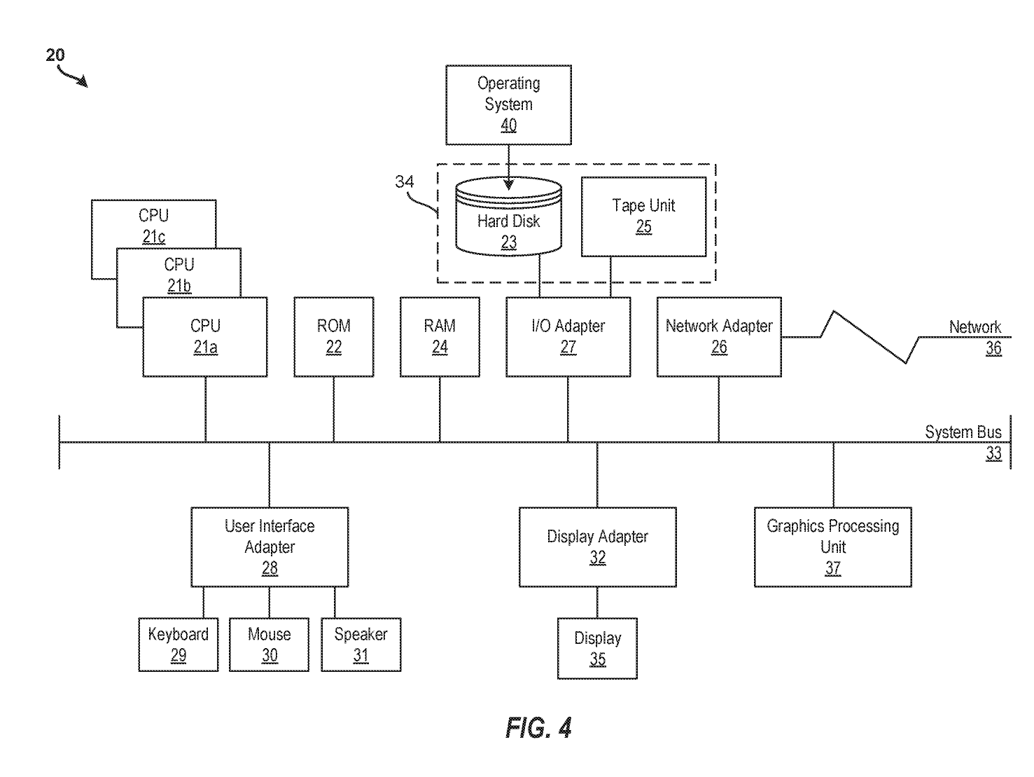

In particular, FIG. 3 illustrates a flow diagram of a method 300 for determining wear of a component used in well operation according to examples of the present disclosure. The method 300 may be performed by a processing system, such as the identification and wear determination system 160 of FIG. 1, the processing system 200 of FIG. 2, the processing system 20 of FIG. 4, and/or by another suitable processing system. In describing the method 300, the modules of the processing system 200 of FIG. 2 are referenced; however, such reference is not intended to be limiting. The method 300 starts at block 302 and continues to block 304.

At block 304 of the method 300, the processing system 200 identifies the component from a plurality of components, wherein an identifier is connected to the component, the identifier comprising a unique identifier to identify the component from the plurality of components.

At block 306 of the method 300, a density sensor senses a volume of sand passing through the component over a period of time. At block 308 of the method 300, a flow sensor measures a volume of fluid passing through the component over the period of time.

At block 310 of the method 300, the processing system 200 determines a failure risk level for the component based at least in part on the volume of sand passing through the component over the period of time and based at least in part on the volume of fluid passing through the component over the period of time.

The method 300 continues to block 312 and ends. However, additional processes also may be included. For example, the method 300 may further include storing the volume of sand flowing through the component over the period of time in a database, and storing the volume of fluid flowing through the component over the period of time in the database. Determining the failure risk level may further include accessing the database to retrieve the stored volume of sand flowing through the component over the period of time and the stored volume of fluid flowing through the component over the period of time.

Further, the method 300 may include reporting, by the processing system, the failure risk level for the component by transmitting the identifier associated with the component and the failure risk level to a user device. The method 300 may also include removing the component from the well operation when the failure risk level exceeds a first threshold. When the failure risk level exceeds a second threshold, the well operation may be halted. It should be understood that the processes depicted in FIG. 3 represent illustrations, and that other processes may be added or existing processes may be removed, modified, or rearranged without departing from the scope and spirit of the present disclosure.

It is understood in advance that the present disclosure is capable of being implemented in conjunction with any other type of computing environment now known or later developed. For example, FIG. 4 illustrates a block diagram of a processing system 20 for implementing the techniques described herein. In examples, processing system 20 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 20.

Further illustrated are an input/output (I/O) adapter 27 and a communications adapter 26 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 may be stored in mass storage 34. A network adapter 26 interconnects system bus 33 with an outside network 36 enabling processing system 20 to communicate with other such systems.

A display (e.g., a display monitor) 35 is connected to system bus 33 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 20 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system such as the AIX® operating system from IBM Corporation to coordinate the functions of the various components shown in processing system 20.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Set forth below are some embodiments of the foregoing disclosure:

### Embodiment 1

A method for identifying and determining wear of a component used in a well operation, the method comprising: identifying, by a processing system, the component from a plurality of components, wherein an identifier is connected to the component, the identifier comprising a unique identifier to identify the component from the plurality of components; measuring, by a density sensor in fluid communication with the component used in the well operation, a volume of sand passing through the component over a period of time; measuring, by a flow sensor in fluid communication with the component used in the well operation, a volume of fluid passing through the component over the period of time; and determining, by the processing system, a failure risk level for the component based at least in part on the volume of sand passing through the component over the period of time and based at least in part on the volume of fluid passing through the component over the period of time.

### Embodiment 2

The method of any prior embodiment, wherein the identifier is a barcode, and wherein identifying the component comprises scanning the barcode to receive the unique identifier of the component.

### Embodiment 3

The method of any prior embodiment, wherein the identifier is a radio frequency identification (RFID) tag, and wherein identifying the component comprises reading the RFID tag to receive the unique identifier of the component.

### Embodiment 4

The method of any prior embodiment, wherein the identifier is a microcontroller comprising an input/output connection connected to the processing system, and identifying the component comprises the microprocessor sending the unique identifier to the processing system.

### Embodiment 5

The method of any prior embodiment, further comprising: storing the volume of sand flowing through the component over the period of time in a database; and storing the volume of fluid flowing through the component over the period of time in the database, wherein determining the failure risk level further comprises accessing the database to retrieve the stored volume of sand flowing through the component over the period of time and the stored volume of fluid flowing through the component over the period of time.

### Embodiment 6

The method of any prior embodiment, further comprising: reporting, by the processing system, the failure risk level for the component by transmitting the identifier associated with the component and the failure risk level to a user device.

### Embodiment 7

The method of any prior embodiment, further comprising: removing the component from the well operation when the failure risk level exceeds a first threshold.

### Embodiment 8

The method of any prior embodiment, further comprising: halting the well operation when the failure risk level exceeds a second threshold.

### Embodiment 9

A system for identifying and determining wear of a component used in a well operation, the system comprising: a memory having computer readable instructions; and a processing device for executing the computer readable instructions, the computer readable instructions comprising: identifying the component from a plurality of components, wherein an identifier is connected to the component, the identifier comprising a unique identifier to identify the component from the plurality of components; measuring a density of a fluid flowing through the component over a period of time; and determining, by the processing system, a failure risk level for the component based at least in part on density of the fluid flowing through the component over the period of time.

### Embodiment 10

The system of any prior embodiment, wherein measuring the density of the fluid flowing through the component over the period of time is performed by a density sensor in fluid communication with the component.

### Embodiment 11

The system of any prior embodiment, wherein the instructions further comprise: halting the well operation when the failure risk level exceeds a second threshold.

### Embodiment 12

The system of any prior embodiment, wherein the instructions further comprise: reporting, by the processing system, the failure risk level for the component by transmitting the identifier associated with the component and the failure risk level to a user device.

### Embodiment 13

The system of any prior embodiment, wherein the identifier is a barcode, and wherein identifying the component comprises scanning the barcode to receive the unique identifier of the component.

### Embodiment 14

The system of any prior embodiment, wherein the identifier is a radio frequency identification (RFID) tag, and wherein identifying the component comprises reading the RFID tag to receive the unique identifier of the component.

### Embodiment 15

The system of any prior embodiment, wherein the identifier is a microcontroller comprising an input/output connection connected to the processing system, and identifying the component comprises the microprocessor sending the unique identifier to the processing system.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

Additionally, the term “about” is intended to include the degree of error associated with measurement of the particular quantity based upon the equipment available at the time of filing the application. For example, “about” can include a range of ±8% or 5%, or 2% of a given value.

While one or more embodiments have been shown and described, modifications and substitutions may be made thereto without departing from the spirit and scope of the invention. Accordingly, it is to be understood that the present invention has been described by way of illustrations and not limitation.

What is claimed is:

1. A method for identifying and determining wear of a component used in a well operation, the method comprising:
identifying, by a processing system, the component from a plurality of components, wherein an identifier is connected to the component, the identifier comprising a unique identifier to identify the component from the plurality of components;
measuring, by a density sensor in fluid communication with the component used in the well operation, a volume of sand passing through the component over a period of time;
measuring, by a flow sensor in fluid communication with the component used in the well operation, a volume of fluid passing through the component over the period of time; and
determining, by the processing system, a failure risk level for the component based at least in part on the volume of sand passing through the component over the period of time and based at least in part on the volume of fluid passing through the component over the period of time.

2. The method of claim 1, wherein the identifier is a barcode, and wherein identifying the component comprises scanning the barcode to receive the unique identifier of the component.

3. The method of claim 1, wherein the identifier is a radio frequency identification (RFID) tag, and wherein identifying the component comprises reading the RFID tag to receive the unique identifier of the component.

4. The method of claim 1, wherein the identifier is a microcontroller comprising an input/output connection connected to the processing system, and identifying the component comprises the microprocessor sending the unique identifier to the processing system.

5. The method of claim 1, further comprising:
storing the volume of sand flowing through the component over the period of time in a database; and
storing the volume of fluid flowing through the component over the period of time in the database,
wherein determining the failure risk level further comprises accessing the database to retrieve the stored volume of sand flowing through the component over the period of time and the stored volume of fluid flowing through the component over the period of time.

6. The method of claim 1, further comprising:
reporting, by the processing system, the failure risk level for the component by transmitting the identifier associated with the component and the failure risk level to a user device.

7. The method of claim 6, further comprising:
removing the component from the well operation when the failure risk level exceeds a first threshold.

8. The method of claim 1, further comprising:
halting the well operation when the failure risk level exceeds a second threshold.

9. A system for identifying and determining wear of a component used in a well operation, the system comprising:
a memory having computer readable instructions; and
a processing device for executing the computer readable instructions, the computer readable instructions comprising:
identifying the component from a plurality of components, wherein an identifier is connected to the component, the identifier comprising a unique identifier to identify the component from the plurality of components;
measuring a density of a fluid flowing through the component over a period of time; and
determining, by the processing system, a failure risk level for the component based at least in part on density of the fluid flowing through the component over the period of time.

10. The system of claim 9, wherein measuring the density of the fluid flowing through the component over the period of time is performed by a density sensor in fluid communication with the component.

11. The system of claim 9, wherein the instructions further comprise:
halting the well operation when the failure risk level exceeds a second threshold.

12. The system of claim 9, wherein the instructions further comprise:
reporting, by the processing system, the failure risk level for the component by transmitting the identifier associated with the component and the failure risk level to a user device.

13. The system of claim 9, wherein the identifier is a barcode, and wherein identifying the component comprises scanning the barcode to receive the unique identifier of the component.

14. The system of claim 9, wherein the identifier is a radio frequency identification (RFID) tag, and wherein identifying the component comprises reading the RFID tag to receive the unique identifier of the component.

15. The system of claim 9, wherein the identifier is a microcontroller comprising an input/output connection connected to the processing system, and identifying the component comprises the microprocessor sending the unique identifier to the processing system.
